(19) United States
(12) Patent Application Publication
(10) Pub. No.: US 2011/0154479 A1
(43) Pub. Date: Jun. 23, 2011

(54) IMAGE FORMING APPARATUS AND IMAGE FORMING METHOD

(75) Inventor: Akihiro Terabe, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/969,769

(22) Filed: Dec. 16, 2010

Related U.S. Application Data
(60) Provisional application No. 61/288,648, filed on Dec. 21, 2009.

(51) Int. Cl. G06F 12/14

(52) U.S. Cl. 726/16

(57) ABSTRACT

According to one embodiment, an image forming apparatus includes, a log authentication information acquiring unit configured to acquire log authentication information indicating whether or not to control browse of a job log in each image forming apparatus, a user authentication unit configured to execute user authentication of a user operating the browse of the job log and acquire a result of the user authentication, a log browse right information acquiring unit configured to acquire log browse right information indicating whether or not to limit the browse of the job log for the user, and a control unit configured to control the browse of the job log, based on the log authentication information, the log browse right information and the result of the user authentication that are acquired.

### CROSS-REFERENCE TO RELATED APPLICATIONS

This application is based upon and claims the benefit of U.S. Provisional Application No. 61/288,648, filed on Dec. 21, 2009; the entire contents of which are incorporated herein by reference.

### FIELD

Embodiments described herein relate generally to an image forming apparatus and an image forming method.

### BACKGROUND

As a form of image forming apparatus, there is an apparatus called multi-function peripheral (MFP). The MFP is a digital multi-function machine which realizes plural functions including the scanner function, facsimile function and image data saving function as well as the copy function, and plays the roles of plural devices on its own.

The MFP saves information including the date and time when a job is executed (hereinafter referred to as job log) in order to grasp the history of use of the apparatus. The MFP has a browse function to show, on a display, a job log saved in response to a user's request. With the job log browse function of the conventional MFP, the user can browse all job logs including the logs of jobs executed by other users. However, since security is becoming increasingly important recently, allowing anyone to browse the logs of jobs executed by others is considered to pose a problem in terms of security.

### BRIEF DESCRIPTION OF THE DRAWINGS

FIG. 1 shows a network configuration using an exemplary image forming apparatus according to an embodiment.

FIG. 2 shows the configuration of an exemplary image forming apparatus according to an embodiment.

FIG. 3 shows the configuration of an exemplary authentication database according to an embodiment.

FIG. 4 shows the configuration of an exemplary role management database according to an embodiment.

FIG. 5 shows an exemplary log authentication setting screen according to an embodiment.

FIG. 6 is a flowchart showing job log browse control in an exemplary image forming apparatus according to an embodiment.

FIG. 7 shows an exemplary authentication screen according to an embodiment.

FIG. 8 shows an exemplary log browse screen according to an embodiment.

FIG. 9 shows an exemplary job log display screen according to an embodiment.

FIG. 10 shows an exemplary job log display screen according to an embodiment.

### DETAILED DESCRIPTION

In general, according to one embodiment, an image forming apparatus includes: a log authentication information acquiring unit configured to acquire log authentication information indicating whether or not to control browse of a job log in each image forming apparatus; a user authentication unit configured to execute user authentication of a user operating the browse of the job log and acquire a result of the user authentication; a log browse right information acquiring unit configured to acquire log browse right information indicating whether or not to limit the browse of the job log for the user; and a control unit configured to control the browse of the job log, based on the log authentication information, the log browse right information and the result of the user authentication that are acquired.

Embodiments of an image forming apparatus and an image forming method according to the invention will be described with reference to the accompanying drawings.

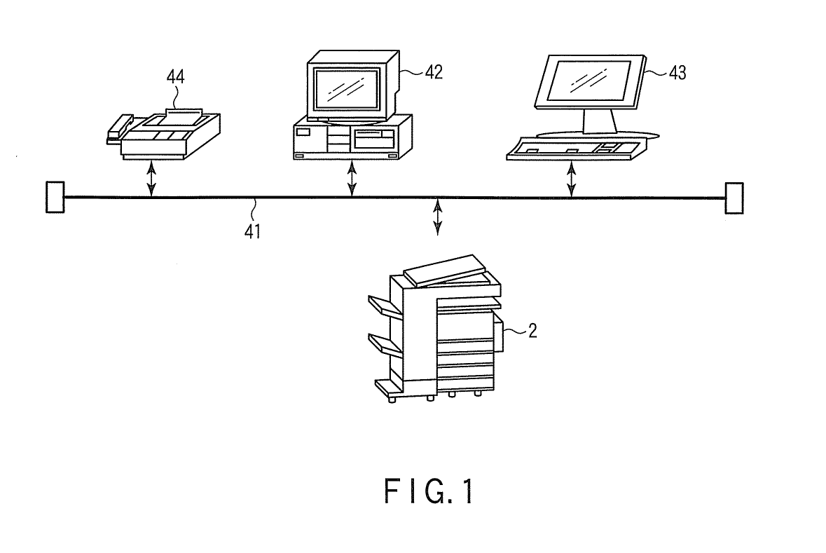

FIG. 1 shows a network configuration using an exemplary image forming apparatus according to an embodiment.

An MFP 2 is connected to personal computers (PCs) 42, 43 and a facsimile device 44 via a network 41. The MFP 2 not only operates according to an operation from a control panel provided in the MFP 2 but also operates according to an input from the PCs connected to the network 41. For example, a general user uses the PC 42 to operate the MFP. A manager uses the PC 43 to operate the MFP. The MFP 2 also acquires information received by the facsimile device 44, via the network.

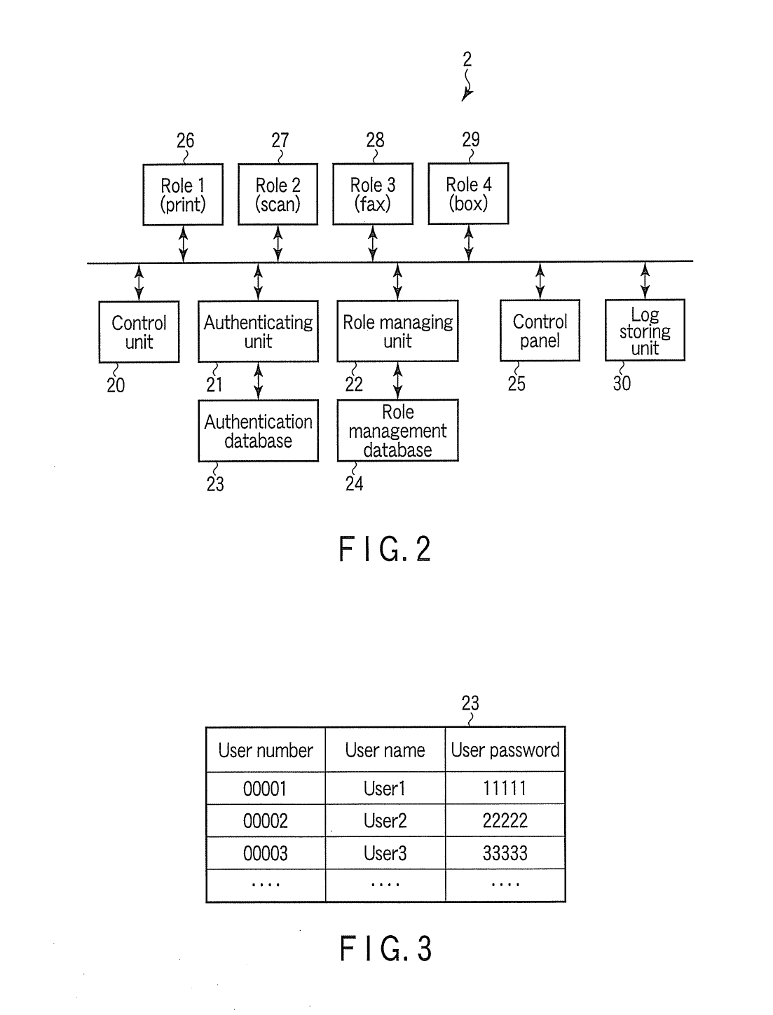

FIG. 2 shows the configuration of an exemplary image forming apparatus according to an embodiment.

The MFP 2 is an apparatus that can play the roles of plural devices, for example, a copier, scanner, facsimile device and image data recording device (box device), on its own.

For example, it is now assumed that the MFP has the following roles: a role (a) as a copier, a role (b) as a scanner, a role (c) as a facsimile device, and a role (d) as an image data saving device. In this case, a user A is permitted to use the role (a) and the role (c) and is prohibited from using the role (b) and the role (d). Meanwhile, another user B is permitted to use the role (a), the role (b) and the role (d) and is prohibited from using the role (c). Such management function is what is called a role management function.

The image data saving device provided in the MFP 2 may have its recording area divided into plural recording areas called boxes (for example, n boxes from a box 1 to a box n). In this case, the role (d) of the image data saving function can be subdivided into a role (d1) to a role (dn) using the boxes 1 to n, respectively. Thus, more detailed management than the role management function can be provided.

In FIG. 2, as an example of the roles of these plural devices, the role of a copier is shown as a role (1) 26. The role of a scanner is shown as a role (2) 27. The role of a facsimile device is shown as a role (3) 28. The role of a box device is shown in as a role (4) 29.

The MFP 2 also has a control unit 20, an authentication unit 21, a role management unit 22, an authentication database 23, a role management database 24, a control panel 25, and a log storing unit 30.

The control unit 20 centrally controls the MFP 2. The control unit 20 may be comprised of central processing unit, read only memory, random access memory, and a plurality of driver ICs. The control panel 25 takes in an instruction to set and execute various functions inputted by the user, and also displays necessary information and thus notifies the user of the necessary information. The authentication unit 21 carries out user authentication by determining whether authentication information inputted from the control panel 25 or the PC 42 coincides with authentication information registered in the authentication database 23.

The role management unit 22 executes role management based on data registered in the role management database 24. In the role management database 24, a role or roles allocated to each user are registered in advance. The role management unit 22 permits the user to use only the allocated role(s).

The control unit 20 determines the type of a job executed in the MFP 2 and executes creation and display of a job log. Information to be logged includes job number, user name, document name, job execution date and time, type of job, document size, sheet size, number of sheets, and so on. Such information is stored in the log storing unit 30 as a job log. FIG. 3 shows the configuration of an exemplary authentication database according to an embodiment. The authentication database 23 is a database used for user authentication. In the authentication database 23, the association between information about the user expressed by “user number”, “user name” and the like, and “user password” as authentication information is registered.

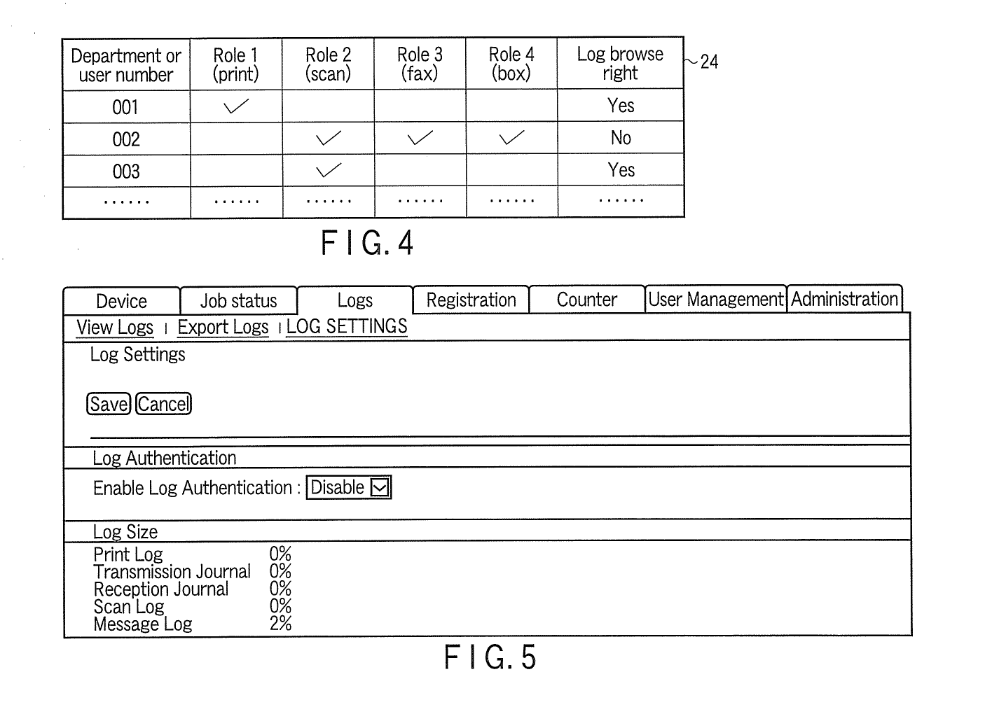

FIG. 4 shows the configuration of an exemplary role management database according to an embodiment. The role management database 24 is a database used for role management for the user. In the role management database 24, the allocation of a role or roles for each user is stored. The tick mark “v” in the table indicates that the role is allocated. A blank indicates that the role is not allocated.

In the example of role allocation for each user, the role (1) is allocated to a “user 1”. The role (2), role (3) and role (4) are allocated to a “user 2”. The role (2) is allocated to a “user 3”.

Moreover, a log browse right section is provided in the role management database 24. If the log browse right is “valid”, the user can browse all the job logs including the logs of jobs executed by other users. Meanwhile, if the log browse right is “invalid”, the user is permitted to browse only the log of a job executed by this user. The log browse right section may be provided independently, instead of being provided in the role management database 24.

The manager sets in advance whether the log browse right is given (valid) or not (invalid) to each user. The log browse right can also be set from the control panel 25 or from the PC 43.

The manager can also carry out log authentication setting. The log authentication setting is the setting of whether or not to limit log browse for each MFP 2. The log authentication setting can also be carried out from the control panel 25 or from the PC 43.

FIG. 5 shows an exemplary log authentication setting screen according to an embodiment. The log authentication setting screen shown in FIG. 5 is displayed by operating a tab on an access screen that is displayed when an operation at the PC 43 is carried out by the manager.

On the access screen, tabs “Device”, “Job Status”, “Logs”, “Registration”, “Counter”, “User Management” and “Administration” are provided.

When the “Device” tab is selected, the configuration of the MFP 2, for example, the configuration of options or the like is displayed. When the “Job Status” tab is selected, the name of a job that is currently being executed or the like is displayed. When the “Logs” tab is selected, a job log or the like can be displayed. When the “Registration” tab is selected, registration to and management of an address book can be carried out. When the “Counter” tab is selected, the number of printed sheets, the number of scanned sheets or the like is displayed. When the “User Management” tab is selected, registration for user authentication, setting for role management and the like can be executed. The “Administration” tab is a tab showing items which only the manager can operate.

Items to be displayed and items that can be set are different between when the manager accesses this access screen and when the general user accesses the access screen. Thus, erroneous operation can be prevented and operation according to the limitation of right can be executed.

The log authentication setting screen shown in FIG. 5 is a screen that is displayed when the manager selects the “Logs” tab and then designates “Log Settings”.

On this log authentication setting screen, the manager can set whether control for log browse should be valid or invalid. That is, when “Disable” in the pull-down menu “Enable Log Authentication” is set, control for log browse is not carried out. When “Enable” is set, control for log browse is carried out.

Next, job log browse control in the image forming apparatus according to this embodiment will be described.

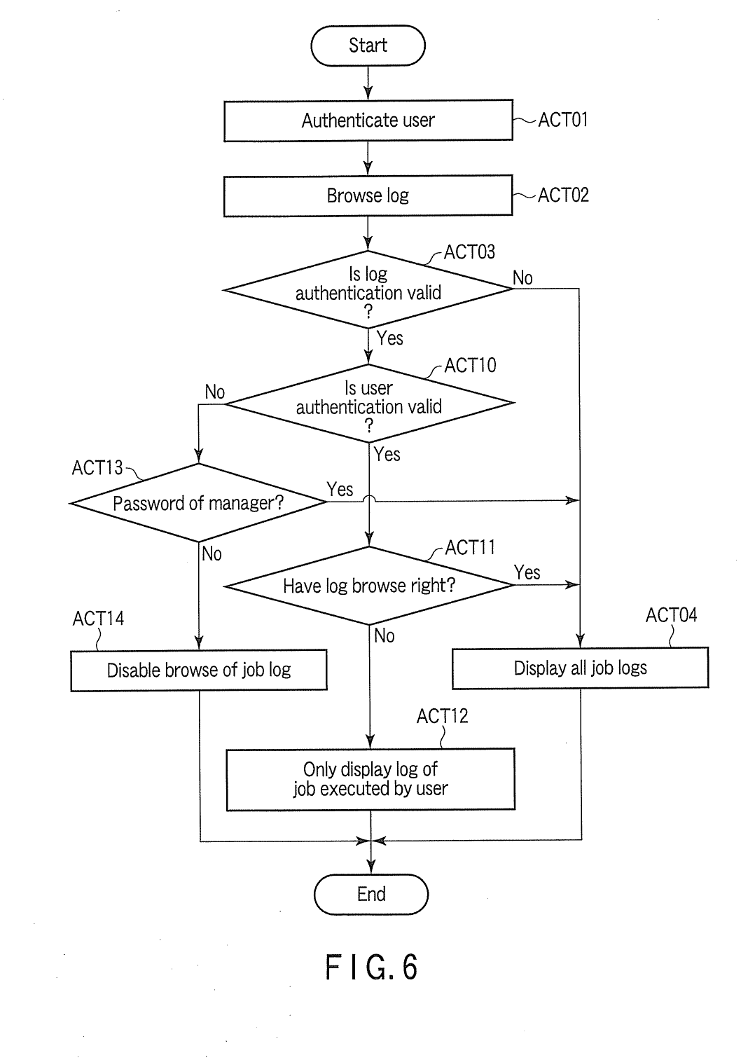

FIG. 6 is a flowchart showing job log browse control in an exemplary image forming apparatus according to an embodiment. Hereinafter, the operation where the user operates the PC 42 will be described.

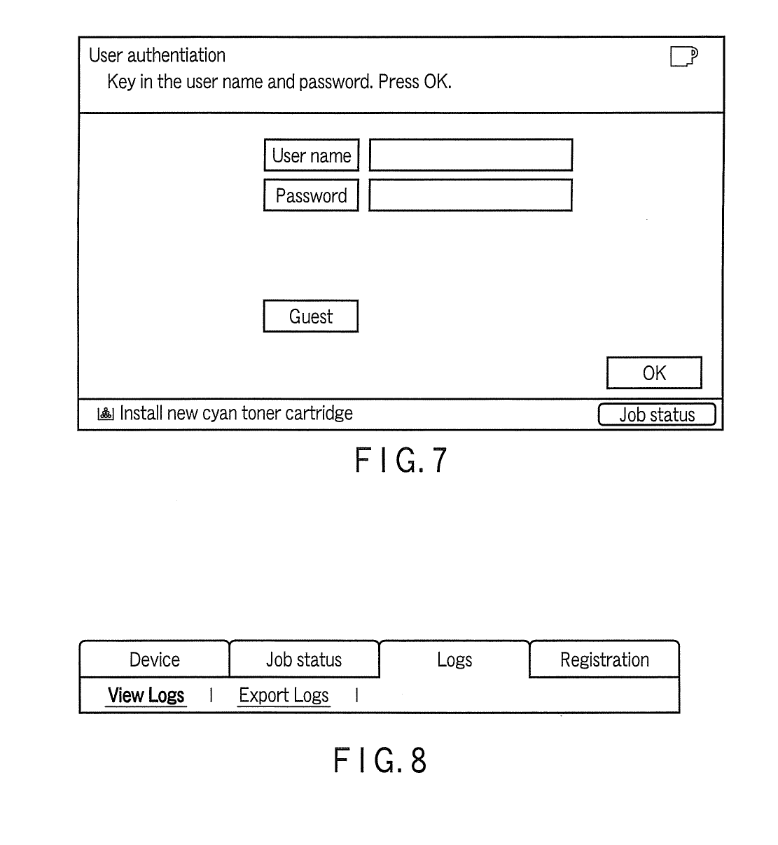

In ACT 01, the user input authentication information via an authentication screen. FIG. 7 shows an exemplary authentication screen according to an embodiment. As the user inputs a user name and password and presses the OK button, the MFP 2 authenticates the user based on the inputted user name and password.

The authentication unit 21 refers to the authentication database 23, and when the inputted user name and password are already registered, the authentication unit 21 determines that the user authentication is valid. When the inputted user name and password are not registered, the authentication unit 21 determines that the user authentication is invalid. Then, it is examined whether the password is an apparatus-specific password that represents the manager or not. When the password representing the manager is inputted, this information is saved.

In ACT 02, the user executes log browse. FIG. 8 shows an exemplary log browse screen according to an embodiment. The user selects the “Logs” tab and then designates “View Logs”.

In ACT 03, the control unit 20 examines whether log authentication (control for log browse) is valid or not. When the log authentication is invalid (No in ACT 03), the control unit 20 in ACT 04 displays all the job logs stored in the log storing unit 30.

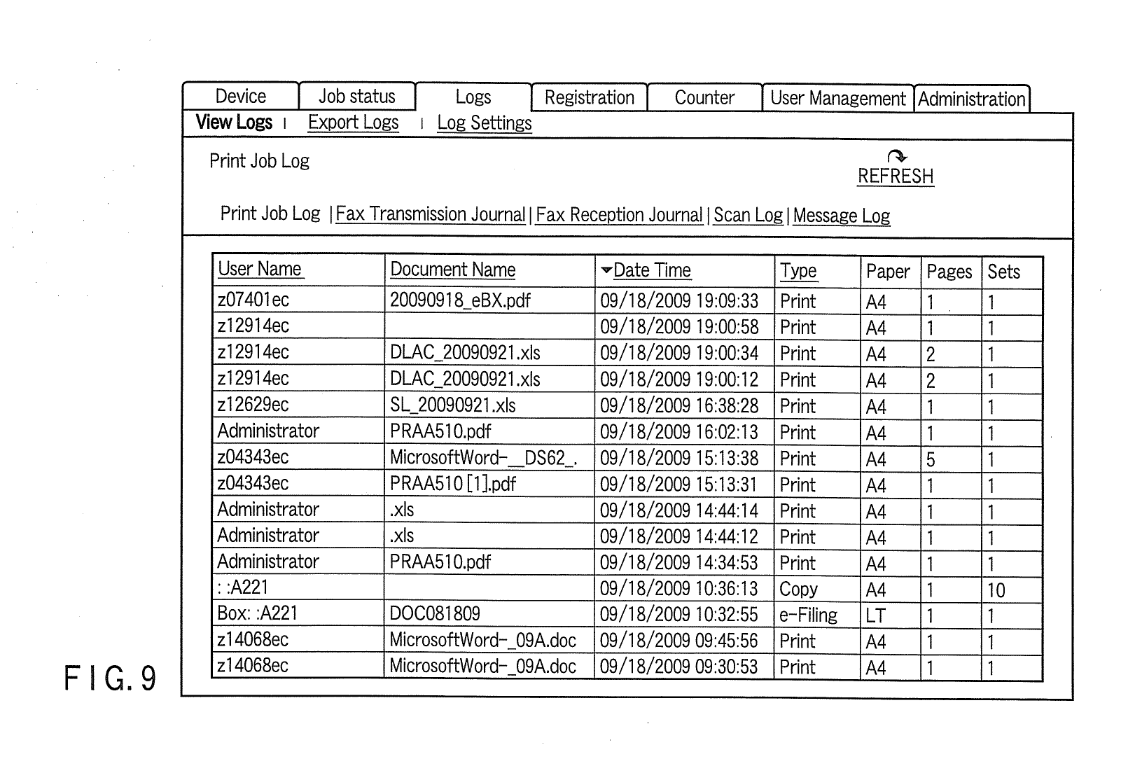

FIG. 9 shows an exemplary job log display screen according to an embodiment. The job log display screen shown in FIG. 9 is a screen that is shown when “Print Job Log” is designated by the user. In “Print Job Log”, the user name, the document name, the job execution date and time, the type of job, the sheet size, the number of sheets and the number of copies are displayed with respect to a job in which printing is carried out, a job in which a copy is carried out, or the like.

The user can designate “Fax Transmission Journal”, “Fax Reception Journal”, “Scan Log” and “Message Log”, other than “Print Job Log”. In “Fax Transmission Journal”, the record of transmitting FAX is displayed. In “Fax Reception Journal”, the record of receiving FAX is displayed. In “Scan Log”, the record of scanning and saving is displayed. In “Message Log”, the record of events such as errors generated in the device is displayed.

As the manager selects the “Logs” tab and then designates “Export Logs”, job log data can be outputted to outside in a predetermined file format, preferably, in the format of CSV, XML or the like.

If the log authentication is valid (Yes in ACT 03), the control unit 20 in ACT 10 examines whether the user authentication is valid or not. If the user authentication is valid (Yes in ACT 10), the control unit 20 in ACT 11 examines whether this user has the log browse right or not. That is, the control unit 20 examines whether there is the log browse right of this user in the role management database 24 or not.

If the user has the log browse right (Yes in ACT 11), the control unit 20 in ACT 04 displays all the job logs stored in the log storing unit 30. If the user does not have the log browse right (No in ACT 11), the control unit 20 in ACT 12 only displays the log of the job that is executed by the user.

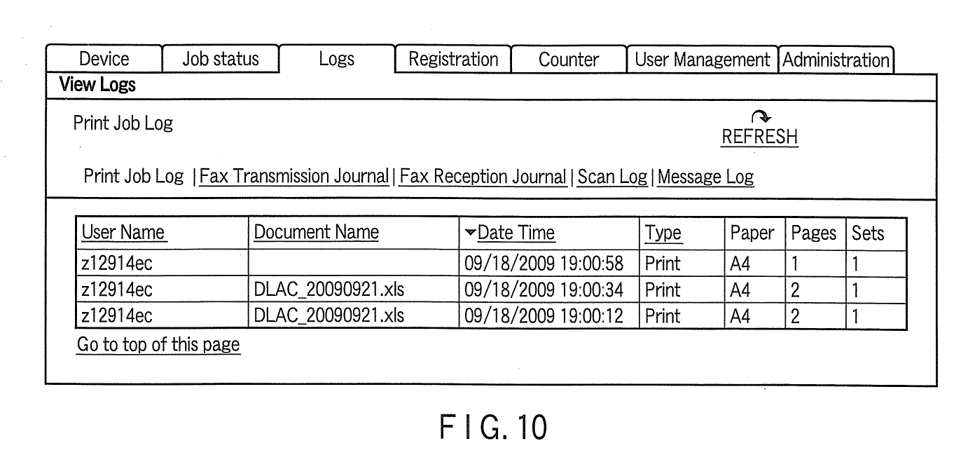

FIG. 10 shows an exemplary job log display screen according to an embodiment. In the job log display screen shown in FIG. 10, only the job executed by the user who is already in the log-in state is displayed.

If the user authentication is invalid (No in ACT 10), it is examined in ACT 13 whether the log-in is done with the preset manager's password (or device-specific password) that is set in advance. If the log-in is done with the manager's password (Yes in ACT 13), the control unit 20 in ACT 04 displays all the job logs stored in the log storing unit 30. If the manager's password is not used (No in ACT 13), the browse of all the job logs is prohibited in ACT 14.

Conventionally, all users are permitted to browse all job logs. In this embodiment, the log authentication setting function to control the log browse by the user is provided. If the log authentication setting is invalid, no limitation to the log browse by the user is given, as in the conventional technique. If the log authentication setting is valid, the log browse by the user is controlled.

The log browse by the user is controlled in the following manner. Even when the user authentication is valid, if this user does not have the log browse right, only the browse of the log of the job executed by this user is permitted. If the user authentication is valid and this user has the log browse right, the user can browse all the job logs, as in the conventional technique.

If the user authentication is invalid, the browse of job logs is prohibited. However, a user who knows the particular device-specific password is regarded as the manager and therefore can browse all the job logs.

Each of the functions described in the above embodiments may be configured using hardware or may be realized by having a computer read a program describing each function with software. Each function may be configured by either software or hardware that is properly selected.

Moreover, each function can also be realized by having a computer read a program that is stored in a recording medium, not shown. Here, the recording medium in this embodiment may have any recording format as long as the recording medium can record the program and can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a log authentication information acquiring unit configured to acquire log authentication information indicating whether or not to control browse of a job log in each image forming apparatus;
a user authentication unit configured to execute user authentication of a user operating the browse of the job log and acquire a result of the user authentication;
a log browse right information acquiring unit configured to acquire log browse right information indicating whether or not to limit the browse of the job log for the user; and
a control unit configured to control the browse of the job log, based on the log authentication information, the log browse right information and the result of the user authentication that are acquired.

2. The apparatus of claim 1, wherein if the log authentication information and the result of the user authentication are valid,
the control unit displays all job logs including a log of a job executed by another user when the log browse right information is valid, and only displays a log of a job executed by this user when the log browse right information is invalid.

3. The apparatus of claim 2, wherein the job log includes a print job, a facsimile reception job, a facsimile transmission job, and a scan job.

4. The apparatus of claim 2, further comprising an export unit configured to output the job log in a predetermined file format.

5. The apparatus of claim 4, wherein the predetermined file format is the CSV or XML format.

6. The apparatus of claim 2, wherein if the log authentication information is valid and the result of the user authentication is invalid,
the control unit displays all job logs including a log of a job executed by another user when authentication information inputted by the user that is used in the user authentication coincides with device-specific information, and prohibits display of job logs when the authentication information does not coincide with the device-specific information.

7. The apparatus of claim 6, wherein the job log includes a print job, a facsimile reception job, a facsimile transmission job, and a scan job.

8. The apparatus of claim 6, further comprising an export unit which outputs the job log in a predetermined file format.

9. The apparatus of claim 8, wherein the predetermined file format is the CSV or XML format.

10. The apparatus of claim 2, wherein if the log authentication information is invalid, the control unit displays all job logs including a log of a job executed by another user.

11. The apparatus of claim 10, wherein the job log includes a print job, a facsimile reception job, a facsimile transmission job, and a scan job.

12. The apparatus of claim 10, further comprising an export unit which outputs the job log in a predetermined file format.

13. The apparatus of claim 12, wherein the predetermined file format is the CSV or XML format.

14. An image forming method comprising:
acquiring log authentication information indicating whether or not to control browse of a job log in an image forming apparatus;
executing user authentication of a user operating the browse of the job log and acquiring a result of the user authentication;
acquiring log browse right information indicating whether or not to limit the browse of the job log for the user; and
controlling the browse of the job log, based on the log authentication information, the log browse right information and the result of the user authentication that are acquired.

15. The method of claim 14, wherein the controlling includes,
if the log authentication information and the result of the user authentication are valid,
displaying all job logs including a log of a job executed by another user when the log browse right information is valid, and only displaying a log of a job executed by this user when the log browse right information is invalid.

16. The method of claim 15, wherein the job log includes a print job, a facsimile reception job, a facsimile transmission job, and a scan job.

17. The method of claim 16, further comprising outputting the job log in a predetermined file format.

18. The method of claim 17, wherein the predetermined file format is the CSV or XML format.

19. The method of claim 15, wherein the controlling includes,
if the log authentication information is valid and the result of the user authentication is invalid,
displaying all job logs including a log of a job executed by another user when authentication information inputted by the user that is used in the user authentication coincides with device-specific information, and prohibiting display of job logs when the authentication information does not coincide with the device-specific information.

20. The method of claim 19, wherein the job log includes a print job, a facsimile reception job, a facsimile transmission job, and a scan job.

21. The method of claim 19, further comprising outputting the job log in a predetermined file format.

22. The method of claim 21, wherein the predetermined file format is the CSV or XML format.

23. The method of claim 15, wherein the controlling includes,
if the log authentication information is invalid, displaying all job logs including a log of a job executed by another user.

24. The method of claim 23, wherein the job log includes a print job, a facsimile reception job, a facsimile transmission job, and a scan job.

25. The method of claim 23, further comprising outputting the job log in a predetermined file format.

26. The method of claim 25, wherein the predetermined file format is the CSV or XML format.
